(19) United States
(12) Patent Application Publication
(10) Pub. No.: US 2007/0008566 A1
(43) Pub. Date: Jan. 11, 2007

(54) 3-D view and edit method and apparatus for document make-ready preparation for book production

(75) Inventors: Anthony J. Leone III, Pittsford, NY (US); Roman Liccini, Los Angeles, CA (US); William Jacobs, Los Angeles, CA (US)

Correspondence Address: OLIFF & BERRIDGE, PLC., P.O. BOX 19928, ALEXANDRIA, VA, 22320, US

(73) Assignee: Xerox Corporation, Stamford, CT (US)

(21) Appl. No.: 11/175,313

(22) Filed: Jul. 7, 2005

(51) Int. Cl. G06F 3/12

(52) U.S. Cl. 358/1.13

(57) ABSTRACT

A prepress application may reduce the amount of time required to view and correct the alignment of page content within a digital image of an electronic document, such as a book, by allowing the operator to visualize a book in three dimensions (3-D), thereby enabling more pages to be viewed at one time. The application may include modules for rendering a 3-D image, moving within a virtual 3-D environment, and editing the document.

### BACKGROUND

The subject matter of this application relates to a document preview and editing system, for example, for previewing and correcting document registration.

When preparing a book for print, make-ready operators verify and correct the consistency of page margins, registration, folios, and the like, by various “prepress” applications offering a traditional two dimensional view of a document. In many cases, the operator is not interested in the individual page content, but rather only in the consistent positioning of content on the book's pages. Some prepress applications allow the operator to view a single page as a transparency with the backside of the page displayed in a different color. While this is somewhat helpful, it does not allow the operator to perceive multiple pages at one time.

Some existing prepress software applications include Xerox's Free-Flow Make-Ready™, Elon-Gmkelan-Gmk's Professional Proofer™ and Ioflex's IOBookmaker™. Each of these applications allows an operator to view a single page of a document as if the page appears on a light table. One function of prepress operations is to ensure that the front-to-back alignment of the pages is sufficiently accurate. Operations may include verification and/or correction of positioning of the page numbers, the page layout, the margins, and the like. The alignment and positioning of these features is an important consideration in preparing files to go to a digital press because limitations in the mechanical tolerances of the printers may cause the page alignment to shift. Therefore, aligning the features during pre-press may minimize defects in the printed document.

Due to industry trends for shorter run-length (production units of a particular book) and decreased cycle times (production cycle time), the amount of time that a print shop can afford to spend in make-ready preparation for a book is decreasing. This trend is due in part to the trend toward desk-top publishing which allows for “print on demand” rather than warehousing large volumes. For example, an order may require a run-length for 3 books rather than an order for a run-length for 300,000 books.

In addition to shorter run-lengths, there is also industry pressure to reduce the production cycle time, i.e., the period of time from when a file arrives at the production operations facility or manufacturing group to actual shipping of the printed book. There is tremendous pressure to decrease the entire production and distribution process so that publisher, retailer and consumer demands are met as quickly as possible. This trend coupled with the use of unskilled operators (those operators without graphic arts training) creates a need for an easy-to-use prepress application.

### SUMMARY

Exemplary/embodiments of systems and methods disclosed herein may reduce the amount of time required to view and correct alignment of page content within a digital image of an electronic document, such as a book, by allowing the operator to visualize a book in three dimensions (3-D), thereby enabling more pages to be viewed at one time. Furthermore, because viewing and editing are often integrated operations, exemplary embodiments may allow changes and/or corrections to be made without using a separate editor and, for example, then saved in a printable format. An operator friendly interface may also be provided.

Current document make-ready applications use traditional 2-D views of a document for the make-ready operator to prepare a book for print. In many cases, the operator is not interested in the page content, but rather the consistency of content positioning within a stack of pages. In exemplary embodiments, a document preview/editing system may be provided that excels at previewing and correcting document registration using a 3-D paradigm to preview a “digital book.” In exemplary embodiments, emphasis toward leveraging advanced graphical gaming capabilities to give a more realistic operator experience is provided. Exemplary embodiments may also serve as a complement to existing 2-D prepress applications, as well a replacement of such applications.

Exemplary embodiments of systems and methods may provide for viewing a plurality of pages of a document “transparently” to allow an operator to see if every page to be printed will align properly. For example, exemplary systems and methods may allow the operator to view the entire multi-page document as if viewed on a light table to determine if any page numbers, headers, margins, or any of the content, is outside of the intended area or placement on a page. By viewing the entire document or at least multiple pages at once, rather than on a single page basis, the operator may obtain a quick, one-glance, view to determine if all of the pages are aligned, or if there is an adjustment to be made, for example, through a viewer/editor module of the application. When correction is required, exemplary embodiments may allow the operator to go directly to the errant page to make the necessary adjustments.

The viewer/editor module may also enable the operator to move within the document to view edges of a page or pages, to pan and rotate, zoom in and zoom out and/or “jump” directly to a certain point in the document, as desired. For example, an operator may look through several pages and see all of the page numbers are in alignment. If a particular page number is out of alignment with the others, exemplary embodiments may allow the operator to jump, or go directly, to that page to make the correction, without having to page through the document.

Exemplary embodiments of systems and methods may also provide prepress applications that may present documents as sliding stacks of sheets with an integrated display of the page characteristics. This may allow for easy identification and/or correction of page margin and/or other misregistration problems.

### BRIEF DESCRIPTION OF THE DRAWINGS

Various exemplary implementations of the system and methods are described in detail with reference to the following figures, wherein:

FIG. 1 shows a schematic view of an exemplary embodiment of the subject matter described herein;

FIGS. 2-4 show exemplary views of a 3-D rendering of an electronic document;

FIGS. 5-7 show exemplary operator interface devices compatible with the subject matter described herein;

FIGS. 8-9 show an initial display of a page stack and a diagonally shifted page stack, respectively;

FIG. 10 shows an initial page stack shifted horizontally, to the right;

FIG. 11 shows an initial page stack shifted vertically downward;

FIG. 12 is a schematic view of a computer having a memory and instructions for executing various systems and methods described herein; and

FIG. 13 is a flowchart outlining one exemplary embodiment of a method for document make-ready preparation.

### DETAILED DESCRIPTION OF EMBODIMENTS

Exemplary embodiments of the subject matter described herein utilize a three-dimensional (3-D) preview of a multi-page digital image document, such as a book, and enable an operator to interact with the document, for example, using gaming control methodologies, as well as other operator interface methodologies. In various exemplary embodiments, the subject matter described herein may be used be used in conjunction with existing 2-D prepress applications, existing editing applications, and/or and may be used as a “stand-alone” prepress application.

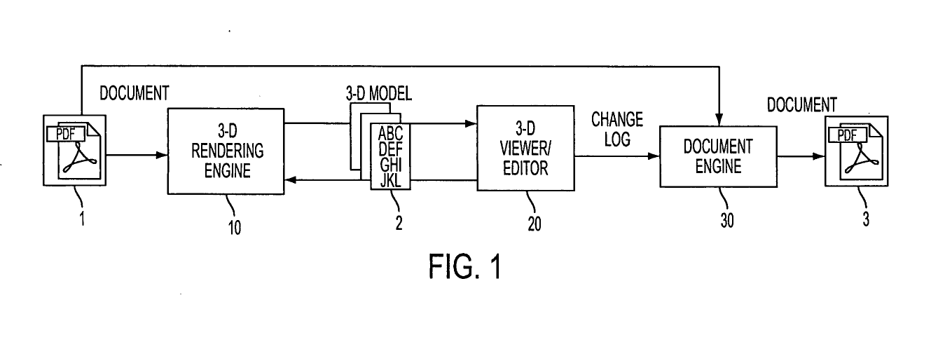

FIG. 1 shows a schematic view of an exemplary embodiment of the subject matter described herein. As shown in the exemplary embodiment of FIG. 1, the subject matter may provide computer readable instructions and an executable system having three modules: (1) a 3-D rendering engine 10; (2) a 3-D viewer/editor 20; and (3) a document engine 30.

The 3-D graphics engine may be similar to that used as the core graphics component of a video game. Such 3-D engines dynamically render all foreground and background objects in a scene including people, animals, trees, machines, buildings, terrain, and sky. These 3-D engine might also handle additional tasks, such as collision detection between game objects, but the most common function is graphics rendering.

The operator interface may also be similar to that of a modern video game. For example, there may be a preview of the pages of a document floating in space, and interface controls that would enable the user to change the location and direction of the operator's perspective, such as described above. The interface may also require a screen used to configure the keys that are used to change the perspective. Editing functions may also require keys to shift the content of the pages left, right, up, and down.

The document engine may provide a facility to store and retrieve complete documents or portions of a document. Note that performance becomes an important feature as the size of a document increases. Another important feature of the document engine is the ability to retrieve, update, delete, insert, and/or replace a selected subset of a document. Every document can be divided up into pages, but some document engines permit additional levels of selection. For example, the Xerox FreeFlow MakeReady™ application permits the user to select and modify chapters, sections, discontinuous selections of pages, and even individual items on the page. If the document is two-sided, the user can also select and exclusively modify front pages or back pages. In many cases, document engines also provide conversion facilities in order to facilitate adding new content to a document.

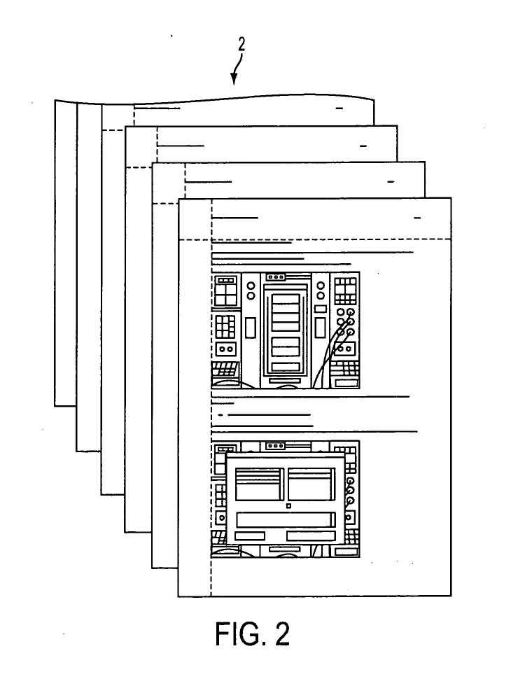

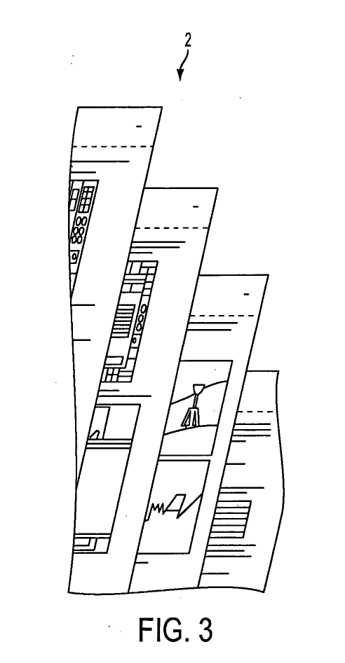

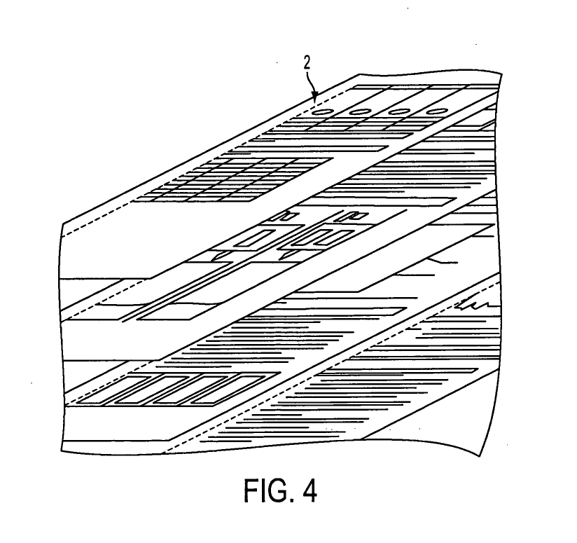

In operation, when the operator selects an electronic file, such as a book to view for prepress or make-ready operations, the 3-D rendering engine 10 may receive a digital document 1 from a storage area (not shown) as input, and may render each page as a 2-D viewable surface. Each page surface may then be mapped to a front or back of a series of rectangles floating in 3-D space that form a three-dimensional model of the document 2, for example, as shown in FIGS. 2-4.

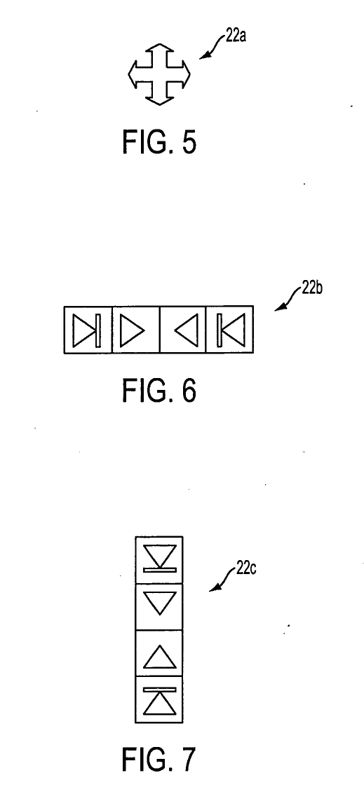

In exemplary embodiments, white space, representing a page of the document 2, is rendered as an opaque or translucent/transparent surface. When the white space is rendered translucent/transparent, the operator may see through the image representing the page to view the front-to-back alignment of content on both sides of the page. Once the 3-D model of the document 2 of the book is rendered, the 3-D viewer/editor 20 may be used to “fly” through the book using an operator interface, for example, as shown in FIGS. 5-7, such as a keyboard, mouse, joystick, touch pad, or other such device for manipulating movement through a 3-D space in a computer or virtual environment.

While viewing the 3-D rendering of the digital document 2, the operator may detect a page number or folio that is not aligned with the other page numbers. Exemplary systems and methods allow the operator to “drill down” or “fly through” the pages of the document 2 until the errant page number is reached. A joystick, or other operator interface 22a-22c, may be employed to control navigation through the pages of the document 2 to enter the document 2 at a point on a certain page by diving through the book pushing the joystick straight forward until the operator reaches the page of the document containing the errant page number. Once the page is reached, the operator may halt movement and enable editing by pressing a button on the joystick, or other control mechanism. In exemplary embodiments, the document view may be switched from a 3-D view to a 2-D view to more easily work on the page using a conventional editing application to correct the aberration. For example, Xerox's Free-Flow Make-Ready™ may be used to correct any aberrations detected. Although such embodiments use a separate pre-existing editing application, the systems and methods described herein contemplate editing a document using an editing application that is part of the viewer/editor 20 as well.

In other exemplary embodiments, the operator may “jump” directly to the errant page number to make the necessary adjustments. In addition to adjustment of page numbers using any of these exemplary systems and methods, other prepress operations may also be performed.

When pages of the document 2 that require adjustment are encountered, the operator may select the page(s) in question and use the controls of the operator interface 22a-22c to shift the content on the page left, right, up, or down, as necessary to obtain proper alignment. The adjustments are recorded by the document viewer/editor 20 and then passed to the document engine 30 for processing. The document engine 30 applies the recorded adjustments to the original version of the book or electronic file resulting in the revised document 3.

By separating the document engine 30 from the 3-D viewer/editor 20 module, new document formats may be supported without modifying the modules 10, 20, 30 related to rendering, viewing, and recording adjustments. Hence, the systems and methods of this application may be independent of document format. Although the exemplary embodiment of FIG. 1 is described as having individual modules, the 3-D rendering engine 10 and the 3-D editor/viewer 20 may also be incorporated into a single module in the same application, or as one or more individual applications.

Once the 3-D view of the document 2 has been rendered by the 3-D rendering engine 10, the operator may move about the 3-D rendered space using the operator interface 22a-22c to view multiple pages of the document 2 simultaneously. The operator interface 22a-22c may also provide controls to zoom in and out of the document to locate and correct errors and to move his/her view of the document 2 forward, backward, upward, downward, left, and right. Note that left and right in this case may mean “crabbing” left and right, or turning left or right. The operator may also be able to “pitch” upward or downward to move about the document 2. These movements are consistent with the controls and movements used in conjunction with modern video games and will enable print shops to hire operators with more gaming experience than printing experience.

As described above, the operator may view the rendered document/book 2 in a 3-D view from a variety of perspectives, such as those shown in FIGS. 2-4, for example. In exemplary embodiments, the document 2 is rendered in a manner similar to a 3-D solid-model (CAD) application. Using the operator interface 22a-22c, the operator may also pan and zoom around the book to see through, for example, the top of the pages to make sure that no content falls into the gutter of the book or into the margins of a page. The operator may also pick a “slice” of the book (one or more pages), and realign the content if desired. The edits are recorded and later applied, resulting in the revised document 3.

In exemplary embodiments of the prepress applications described herein, documents are presented as sliding stacks of sheets. The sheets or pages may have an associated set of layout and imposition properties such as margins, gutter, imposition scheme, rotation, mirroring, etc. Such embodiments provide easy identification and correction of page margin, misregistration, and/or other problems.

In such embodiments, when the operator retrieves a document 1, such as a book, each page of the digital document 1 will be rendered as the skin of a two dimensional surface by the 3-D rendering engine 10. Each page surface is then mapped to the front or back of a series of rectangles arranged as a three dimensional stack of sheets, or page stack, representing the 3-D document 2. Once the document 2 has been rendered in this way, the 3-D viewer/editor 20 allows the operator to slide pages of the page stack 2 diagonally, horizontally, or vertically. In exemplary embodiments, a control, or user interface 22a-22c allows the operator to choose a diagonal, horizontal or vertical direction in which the pages of the page stack 2 are to be moved. Another control 22a-22c allows the operator to shift the pages one-by-one, or to go directly to the top or bottom of the stack of pages 2.

An aspect of the viewer/editor 20 provides an overlay function on the displayed pages as lines indicating the appropriate margins. For example, top and bottom margins for horizontal document shifts, left and right margins for vertical document shifts may be overlayed. Any page content crossing these lines is quickly identified and the appropriate pages can be flagged, and corrected via a separate editor, or the viewer/editor 20.

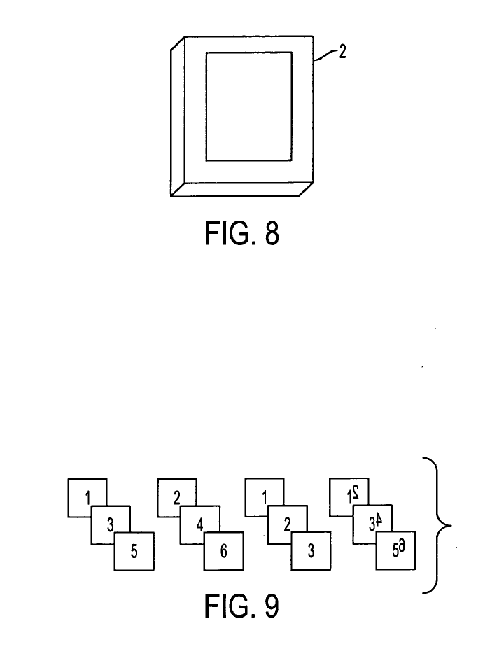

FIGS. 5-7 show exemplary user interface devices compatible with the subject matter of this application. FIG. 5 shows an operator interface 22a, such as a joystick or arrow keys, that permits shifting a page stack (FIG. 8), representing the 3-D document 2, in the left, right, up, down, and diagonal directions. FIG. 6 shows an operator interface 22b that permits the operator to choose the style of display for the pages of the document 2. For example, as shown in FIG. 9, the operator may choose to display only the pages appearing on the recto side of opaque sheets (pages 1, 3, 5), only the pages appearing on the verso side of the opaque sheets (pages 2, 4, 6), all of the pages on the opaque sheets (pages 1, 2, 3, . . . ) or all of the pages on translucent sheets (shown by the pages to the extreme right of FIG. 9).

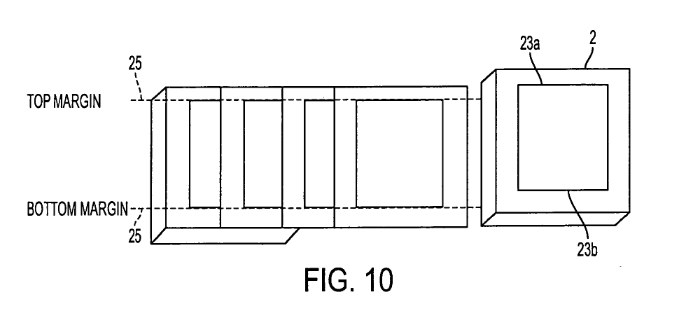

The operator interface 22b shown in FIG. 6 also permits traversing to the beginning or to the end of a page stack, as well as traversing pages forward and backward one page at a time. As shown in FIG. 10, if the page stack representing the document 2 is shifted horizontally to the right, the tops and bottoms of the stack appear with some number of the pages in between shown shifted slightly from one another. Such sliding or shifting of the pages permits inspection of the top and bottom margins 23a, 23b.

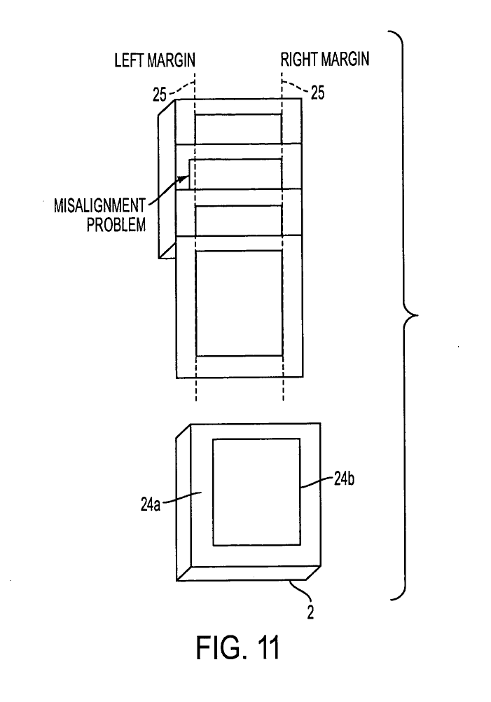

The operator interface 22c shown FIG. 7 permits the page stack 2 to be shifted vertically in a downward or upward direction, as shown in FIG. 11. Such a shift allows some of the tops and bottoms of the pages to appear with some number of pages in between show slightly shifted from one another. The shift or slide of the pages permits inspection of the left and right margins 24a, 24b.

In exemplary embodiments, overlaid on the page stack 2 are lines 25 indicating a selected margin position. The pages appear to move past the operator, permitting a quick consistent method of verifying and identifying any problematic pages of the document 2. Rendering the display of a sheet as translucent/transparent, rather than opaque, provides a further benefit of supporting page registration. Once any page margin 23a, 23b, 24a, 24b or other registration problems are located, the operator can make the necessary corrections using the viewer/editor 20.

In exemplary embodiments, the viewer/editor 20 provides for operation of the appropriate display type in an automatic mode. In other words, the viewer/editor 20 will locate and display those pages with problematic or “out of bounds” content. When such pages are located, the appropriate multi-page display (diagonal, horizontal or vertical shift) with margin indicators then will facilitate any needed manual user intervention.

The viewer/editor 20 also allows for controlling or shifting a distance between successive displayed pages to aid in determining the number of pages being simultaneously displayed between the source and destination page stack. The operator may then tradeoff the simultaneous display of more pages, thereby helping facilitate cross page consistency versus display resolution.

The viewer/editor 20 also supports checking and repairing documents using different recto and verso margins. Therefore, the operator is allowed to display only recto or verso sheet sides of the desired pages. For example, in bound books, it is often the case that the inside spine margin and the outside margin will differ. Thus, prepress applications require consistent placement among all of the recto sides and all of the verso sides, not consistency between the recto and verso sides, to insure proper publication.

The viewer/editor 20 also allows the operator to render the white space (representing the page) as either an opaque or a translucent/transparent surface. When rendered opaque, the viewer/editor 20 allows for the viewing of placement of the page content relative to the page margins 23a, 23b, 24a, 24b. When rendered translucent/transparent, the viewer/editor 20 allows the operator to see through the page, thereby allowing the operator to check for front-to-back content alignment on both sides of the page. Such translucent display is particularly important to address placement for bound books.

The systems and methods of this application may be compatible with industry standards such as Adobe's™ PDF (portable document format), as well as proprietary formats, such as Postscript™ and PDF, as well as public domain formats. The document viewer/editor 20 converts files in any known format and create a bitmap of the same visualization because the 3-D display that is presented on the monitor is a raster display composed of pixels to generate the 3-D view.

For example, if an electronic document is stored in a memory of a computer as a Word™ document, the document is converted from the native book format to a 3-D view or rendering of the document. The rendered image will include, for example, all of the text and font calls, images, graphics, and the like. All of the resultant bitmaps would be cached until needed by the 3-D engine. The 3-D engine would apply these bitmaps as skins on 2-D surfaces representing pages. In exemplary embodiments, systems and methods of this application may be implemented on a computer having instructions for executing such make-ready operations, for example, as described herein. Another method of conversion could be to dynamically convert the portions of the document that are currently being displayed in the 3-D preview.

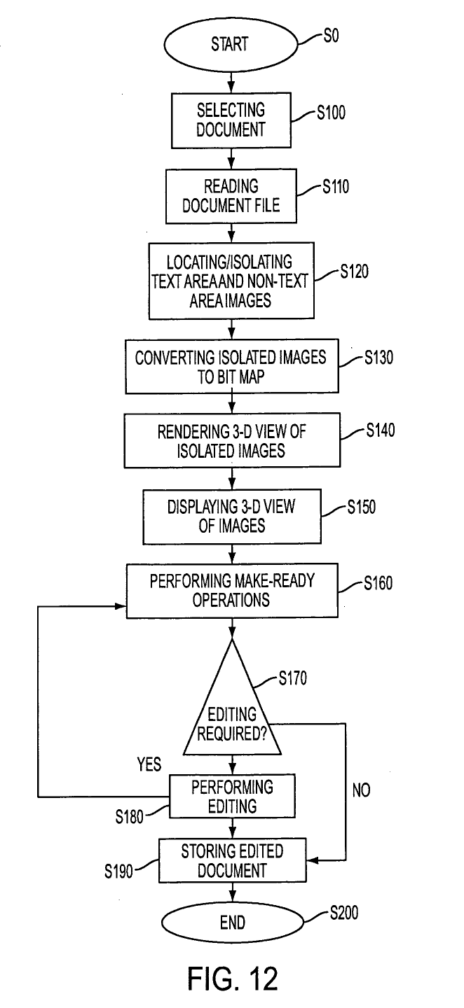

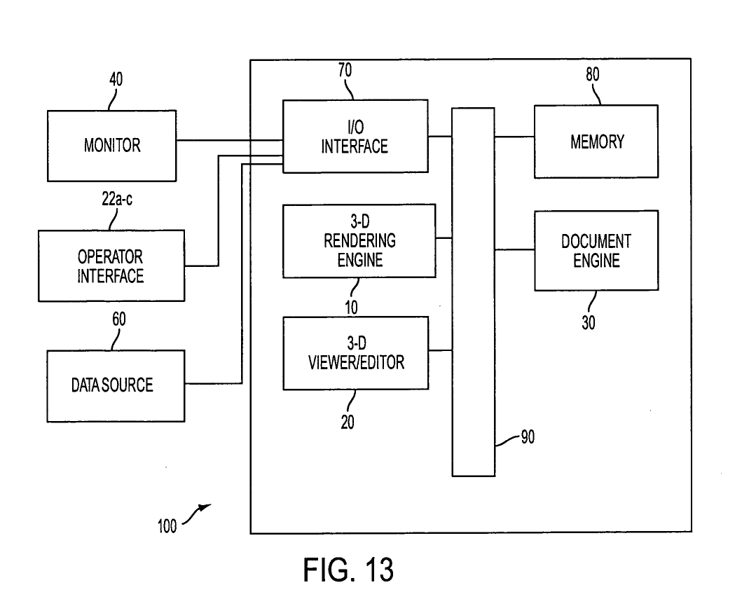

FIG. 12 shows a schematic view of a computer having a memory and instructions for executing various systems and methods of this application. As shown in FIG. 13, a computer 100 includes the 3-D rendering engine 10, the 3-D viewer/editor 20 and the document engine 30. Each of the 3-D rendering engine 10, the 3-D viewer/editor 20 and the document engine 30 may be represented as modules of a software application, firmware or hardware, i.e., circuit. The engines or modules may be provided as individual modules or in any combination. The modules 10, 20, 30 may be used in conjunction with other software applications, such as existing document editing applications, and existing prepress applications.

The computer 100 also includes an input/output interface 70, and a memory 80 interconnected with the modules 12, 20, 30 through a bus 90. An operator interface 22a-c is operably connected to the computer 100 via the I/O interface 70. At least one data source 60 may also be operably connected to the computer 100. The data source may be at a remote location from the computer 100 and operably connected to the computer 100. A monitor 40 is in operable communication with the computer 100 via the I/O interface 70.

FIG. 13 is a flowchart outlining one exemplary embodiment of a method for document make-ready preparation. Although any multi-page document may be processed by the following steps, a book being made ready for printing will be described in the following example.

In operation, the process begins in step S0 and continues to step S100 in which the operator selects an electronic document 1, such as a book, to view using a computer, for example, including systems and methods described herein. The electronic document 1 may be stored in the memory 80 of the computer 100 or may be stored at a remote location, such as at the data source 60.

Upon selection of the document 1, the selected pages of the document file is retrieved and read. The format of the selected document is detected by the document engine and rasterized for use with the 3-D rendering engine 10.

The process continues to step S130 in which the proper algorithm or conversion application is selected from a memory (not shown) via the document engine, and a bit map, or other compatible format is passed to the 3-D rendering engine. Alternatively, the memory 80 of the computer 100 may be used for storing the algorithm or conversion application. In exemplary embodiments, each page of the document 1 that is being displayed will be rendered as a 2-D page and then combined with other pages of the document to create an edge profile of a stack of pages.

The 2-D converted images are then rendered as skins on various 2-D pages floating in 3-D space in step S140 by the 3-D viewer editor 10. In this way, system performance can be optimized as distant pages do not have to be rendered unless they are in front of the viewer. In this example, the rendered image is displayed in step S150 as a 3-D rendering of the book 2 on a display device, such as the monitor 40. The monitor 40 may be part of and/or connected to the computer 100, or may be separate or remote. In other words, an operator may be at a remote location and access the computer 100 via a LAN, WAN, intranet or Internet.

The process continues to step S160 in which make-ready operations are performed using the 3-D editor/viewer 20 to view the book 2 to determine if the book 2 requires editing, i.e. locating deviations from a desired position of page content. Using the viewer/editor 20, an operator may select the background for each page of the page stack as transparent/translucent or opaque to allow the operator to create what effectively is the edge profile of the page stack.

In step S170, the operator makes a determination of the necessity of editing the book 2 by reviewing the pages of the book. The review may include “flying through” the book in a virtual three dimensional space, as in a video gaming environment, sliding the pages of the three dimensional book, or otherwise manipulating the 3-D view of the book to view the pages of the book 2.

The operator may use the operator interface 22a-22c to “fly through” the book as though playing a modern video game using a keyboard, mouse, joystick, touchpad, or other such device for manipulating movement through a 3-D space in a computer environment.

If an edit is needed (a Yes decision) editing is performed in step S180 using editor component of the 3-D viewer/editor 20. When pages of the book/document 2 that require adjustment are encountered, the operator may select the page(s) in question and use the controls of the operator interface 22a-22c to shift the content on a selected page left, right, up, or down. Alternatively, a pre-existing editing application may be used with the systems and methods described herein. In exemplary embodiments, the operator may switch the 3-D view to a 2-D view to make any desired revisions to the document.

Upon performing the edit in step S180, the operator will continue to move through the book to determine if additional edits are required. In the process shown in FIG. 13, the process returns to step S160 to perform further make-ready operations. The process will continue through steps S160 to S180 until the operator determines no further edits are necessary. Edits can be recorded as scalars (like a margin) or as page-level matrices that shift all the objects on the page.

If a No determination is made in step S170, the process continues to step S190 in which any edits and/or other adjustments made to the original version of the original book or electronic file are sent to the document engine 30 as a change log. The document engine 30 applies the changes and stores the edited document in the memory 80 and/or in a memory of the data source 60 in step S190. Note that the bitmaps created during the 3-D viewing process can be discarded after the viewing process is complete. The documented edits can be applied to the document using the most expedient method. For document formats where every objects is located in space by a coordinates system, a page-level matrix may the most expedient way to shift all of the data on the page. For other formats, applying a scalar margin might be simpler, Either way, the process then continues to step S200 and ends.

The subject matter described herein is compatible with a variety of features present in existing document software applications. Such features include items like logical preview (viewing the finished book) vs. physical preview (viewing the sheets as they come out of the printer). In both cases, registration may be validated, but the physical preview aspect enables the operator to verify items such as signature shift, color keys, trim marks, etc. It is also possible to use a three-dimensional preview in conjunction with a WYSIWYG preview of the pages destined for presses, color printers, monochrome printers, or even highlight color printers.

For example, in exemplary embodiments, the systems and methods described herein allow viewing and editing of multi-page educational documents, such as books. Educational books often include annotations regarding federal, state, and/or school district educational mandates that the teachers are required to adhere to in order to fulfill certain educational requirements. Such annotations are often denoted by a “spot color”. Upon rendering a 3-D view of such a book, the book may be reviewed specifically for spot color by performing a 3-D fly through of the book. By rapidly locating a desired spot color, the position of the annotation, as well as the content may be reviewed and/or edited.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A machine readable medium containing instructions for performing make-ready operations on an electronic document when the instructions are executed by a processor, comprising:
instructions for rendering a document in a first format that is viewable in two dimensions as a document in a second format that is viewable in three dimensions;
instructions for performing make-ready operations to modify the document in the three-dimensional format;
instructions for converting the modified document from the second format to the first format; and
instructions for storing the modified document in the first format.

2. The machine readable medium as recited in claim 1, wherein the instructions for rendering the document include instructions for reading a document file and mapping each page of the document to a side of a rectangle floating in a three-dimensional space to form a three-dimensional model of the document.

3. The machine readable medium as recited in claim 1, wherein the instructions for rendering include instructions for presenting each page of the document as one of an opaque page, a translucent page, and a transparent page.

4. The machine readable medium as recited in claim 1, wherein the instructions for rendering are provided as a rendering module.

5. The machine readable medium as recited in claim 1, wherein the instructions for performing make-ready operations include instructions for moving through the document in the three-dimensional format to locate deviations from a desired position of page content.

6. The machine readable medium as recited in claim 5, wherein the instructions for moving through the document include instructions for moving in a desired direction in any of the three-dimensions to locate deviations from a desired position of page content.

7. The machine readable medium as recited in claim 5, wherein the instructions for moving through the document include instructions for shifting a plurality of pages in one of a diagonal, horizontal, and vertical direction to locate deviations from a desired position of page content.

8. The machine readable medium as recited in claim 1, wherein the instructions for performing make-ready operations include instructions for correcting deviations from a desired position of page content in one of the two-dimensional view and the three-dimensional view.

9. The machine readable medium as recited in claim 1, wherein the instructions for performing make-ready operations are provided as a viewer/editor module.

10. The machine readable medium as recited in claim 9, wherein the viewer/editor provides an overlay function on displayed pages of the three-dimensional document as lines indicating desired margins.

11. The machine readable medium as recited in claim 9, wherein the viewer/editor provides for operation of a desired display type in an automatic mode.

12. The machine readable medium as recited in claim 9, wherein the viewer/editor provides for controlling a distance between successive displayed pages of the three-dimensional document to aid in determining a number of pages being simultaneously displayed between a source page and a destination page in the three-dimensional document.

13. The machine readable medium as recited in claim 9, wherein the viewer/editor provides for determining and repairing the three-dimensional document having different recto and verso margins.

14. The machine readable medium as recited in claim 9, wherein the viewer/editor provides for rendering white space in the three-dimensional document as at least one of opaque for the viewing of placement of page content relative to page margins and a translucent/transparent surface for viewing front-to-back page content alignment on both sides of a page of the three-dimensional document.

15. The machine readable medium as recited in claim 1, wherein the instructions for converting and the instructions for storing are provided as a document engine module.

16. A method of performing make-ready operations on an electronic document, comprising:
rendering a document in a first format that is viewable in two dimensions as a document in a second format that is viewable in three dimensions;
performing make-ready operations to modify the document in the three-dimensional format;
converting the modified document from the second format to the first format; and
storing the modified document in the first format.

17. The method of claim 16, wherein rendering the document includes reading a document file and mapping each page of the document to a side of a rectangle floating in a three-dimensional space to form a three-dimensional model of the document.

18. The method of claim 16, wherein performing make-ready operations includes moving through the document in the three-dimensional format to locate deviations from a desired position of page content.

19. The method of claim 16, further comprising applying desired changes to the three-dimensional document and storing the changes as a change log in a memory.

20. A computer apparatus comprising a storage medium in which is stored program code for performing make-ready operations on an electronic document, the program code comprising:
instructions for selecting and reading a document file and converting the document file into a bit map;
instructions for rendering the bit map as a three-dimensional view of a document representing the document file;
instructions for performing make-ready operations to modify the document in a virtual three-dimensional space;
instructions for moving within the three-dimensional space to locate deviations from a desired position of page content within the document;
instructions for correcting located deviations; and
instructions for storing corrections made to the document and storing the document as a document file.
